(19) United States
(12) Patent Application Publication
(10) Pub. No.: US 2023/0326732 A1
(43) Pub. Date: Oct. 12, 2023

(54) ION SPECTROMETER

(71) Applicant: SHIMADZU CORPORATION, Kyoto-shi Kyoto (JP)

(72) Inventor: Masaji FURUTA, Kyoto-shi Kyoto (JP)

(73) Assignee: SHIMADZU CORPORATION, Kyoto-shi Kyoto (JP)

(21) Appl. No.: 18/024,128

(22) PCT Filed: Apr. 26, 2021
(86) PCT No.: PCT/JP2021/016632

§ 371 Date: Mar. 1, 2023

(30) Foreign Application Priority Data
Sep. 4, 2020 (JP) 2020-148809

(51) Int. Cl. H01J 49/00; H01J 49/06

(52) U.S. Cl. CPC H01J 49/005; H01J 49/063

(57) ABSTRACT

An ion spectrometer includes: a reaction chamber to dissociate ions derived from a sample component by causing the ions to react with radical species; a cylindrical part constituting a part of the reaction chamber and having openings at both ends; a plurality of electrodes disposed inside the cylindrical part to surround an axis that is linear along an extending direction of the cylindrical part, the electrodes extending in a direction along the axis; a heating part to heat the plurality of electrodes; a pair of electrode holding parts respectively provided in openings at both ends of the cylindrical part and having holes into which electrode support pins described later are respectively inserted; and the electrode support pins of a rod shape each provided on a surface facing the pair of electrode holding parts in each of the plurality of electrodes and extending parallel to the axis.

### TECHNICAL FIELD

The present invention relates to an ion spectrometer such as a mass spectrometer or an ion mobility spectrometer, and more particularly to an ion spectrometer including a cell configured to dissociate ions.

### BACKGROUND ART

In a tandem mass spectrometer such as a triple quadrupole mass spectrometer (see Non Patent Literature 1) or a quadrupole-time-of-flight mass spectrometer, a collision cell (collision chamber) configured to dissociate ions is provided between a mass separation unit at a front stage and a mass separation unit at a rear stage. In a general tandem mass spectrometer, a collision gas such as argon is supplied into the collision cell, and by causing ions introduced into the collision cell to collide with the collision gas, that is, by collision-induced dissociation (CID), ions are dissociated.

When structural analysis of organic compounds such as peptides and lipids is performed, CID does not necessarily generate product ions useful for structural analysis. On the other hand, in recent years, a technique has been developed in which ions derived from a target compound are irradiated with radical species such as hydrogen radicals, oxygen radicals, and nitrogen radicals, so that the ions are dissociated (see, for example, Patent Literature 1 and Non Patent Literature 2). For ions derived from a peptide, for example, various types of product ions reflecting the structure of the peptide such as the amino acid sequence can be generated by performing a dissociation operation using such radical species. The structure of the peptide can be estimated by analyzing mass spectrum in which the product ions are observed.

In Non Patent Literature 2 and the like, the dissociation technique using the radical species as described above is called Hydrogen Attachment/Abstraction Dissociation (HAD), and this term may also be used in the present specification. Note that, a collision cell is originally an instrument that performs CID in its internal space, but in the present specification, a cell performing HAD in its internal space is also referred to as a collision cell.

### CITATION LIST

### Patent Literature

Patent Literature 1: JP 2019-191081 A

### Non Patent Literature

Non Patent Literature 1: “LCMS™-8040 ultra-high speed triple quadrupole LC/MS/MS system”, [online], [searched on Apr. 6, 2020], Shimadzu Corporation, Internet <URL: https://www.an.shimadzu.co.jp/lcms/lcms8040/8040-2.htm>

Non Patent Literature 2: Yuji Shimabukuro and four others, “Tandem Mass-Spectrometry of Peptide Ions by Microwave Excited-Hydrogen and Water Plasmas”, Analytical Chemistry, 2018, Vol. 90, No. 12, pp. 7239-7245

### SUMMARY OF INVENTION

### Technical Problem

In HAD, various types of radical species such as a hydrogen radical, an oxygen radical, and a nitrogen radical are used depending on the type of a target compound, but there are the following problems when an oxygen radical is used.

In a collision cell, an ion guide is disposed that forms an electric field for converging and transporting the introduced ions and the generated product ions. In general, the ion guide has a multipole configuration such as a quadrupole and an octapole, and a plurality of electrodes constituting the ion guide are made of metal (normally stainless steel). When oxygen radicals are supplied into the collision cell, some of the oxygen radicals attach on the surface of the electrodes and oxidize (corrode) the electrodes. When the surface of the electrodes is oxidized, the electric field formed by the electrode is disturbed, and the performance such as ion convergence is deteriorated. As a result, the amount of product ions extracted from the collision cell decreases, and accuracy and sensitivity of the analysis decrease. In addition, complicated maintenance work such as replacement of the electrodes constituting the ion guide needs to be performed.

The present invention is made to solve such problems, and a main object of the present invention is to prevent oxidation of electrodes due to radical species supplied to a collision cell and to ensure high reliability over a long period of time in a mass spectrometer using HAD.

### Solution to Problem

A mode of an ion spectrometer according to the present invention made to solve the above problems is an ion spectrometer including a reaction chamber configured to dissociate ions derived from a sample component by causing the ions to react with radical species, the ion spectrometer includes:
a cylindrical part constituting a part of the reaction chamber and having openings at both ends;
a plurality of electrodes disposed inside the cylindrical part to surround an axis that is linear along an extending direction of the cylindrical part, the electrodes extending in a direction along the axis;
a heating part configured to heat the plurality of electrodes;
a pair of electrode holding parts respectively provided in openings at both ends of the cylindrical part and having holes into which electrode support pins described later are respectively inserted; and
the electrode support pins of a rod shape each provided on a surface facing the pair of electrode holding parts in each of the plurality of electrodes and extending parallel to the axis.

In order to avoid corrosion of electrode due to oxygen radicals as described above, it is preferable that an electrode itself is formed of a metal that is hardly corroded such as gold or platinum, or a layer of the metal that is hardly corroded is formed on a surface of a base member made of another metal (for example, stainless steel) by plating or the like. However, according to study of the present inventor, the corrosive force of the oxygen radical is so strong that an oxide is easily formed on a surface of, for example, a gold-plated electrode made of stainless steel. In order to remove oxide formed on a surface of gold, it is known in the semiconductor field and the like that heating to about 100 to 150° C. in vacuum is effective. But in a normal collision cell using CID, there is no need to heat an electrode to such a temperature, and therefore heat resistance is not considered. Since the holder that holds the electrodes is normally made of resin, when the electrodes are heated to a high temperature in a normal collision cell, the holder may melt. Even if it does not reach such a state, positional displacement of the electrodes due to thermal expansion of the holder or the like occurs, and ions cannot be appropriately converged and transported.

### Advantageous Effects of Invention

On the other hand, in the above mode of the ion spectrometer according to the present invention, the plurality of electrodes in the reaction chamber (for example, the collision cell) are held by the pair of electrode holding parts via the electrode support pins of a rod shape parallel to the axis extending in the same direction as the extending direction of the electrodes. When the electrodes are heated by the heating part, the heat of the electrodes is transmitted to the electrode holding parts mainly through the electrode support pins. Therefore, when the electrode support pins are made of a material having a low thermal conductivity, thermal conduction from the electrodes to the electrode holding parts can be suppressed. In addition, by reducing the cross-sectional area of each electrode support pin and increasing the thermal resistance, heat conduction to the electrode holding parts through the electrode support pins can be further suppressed. In addition, the electrodes can be properly positioned by inserting the electrode support pins provided on the electrodes into the holes in the electrode holding parts. That is, the electrode support pins can have both a function of heat insulation and a function of positioning the electrodes.

With the above mode of the ion spectrometer according to the present invention, since the electrodes for ion convergence and transportation disposed in the reaction chamber can be appropriately heated in vacuum, an oxide formed on the surfaces of the electrodes due to an action of radical species can be removed. Accordingly, oxidation and corrosion of the electrodes can be prevented, and high reliability can be secured for a long period of time.

### BRIEF DESCRIPTION OF DRAWINGS

FIG. 1 is a schematic block diagram of a triple quadrupole mass spectrometer according to one embodiment of the present invention.

FIG. 2 is a schematic perspective view of a collision cell in the mass spectrometer according to the present embodiment.

FIG. 3 is an exploded perspective view of the collision cell in the mass spectrometer according to the present embodiment.

FIG. 4 is a schematic longitudinal sectional view of the collision cell in the mass spectrometer according to the present embodiment.

FIG. 5 is an explanatory view of a fitting structure of components of the collision cell in the mass spectrometer according to the present embodiment.

FIG. 6 is another explanatory view of the fitting structure of components of the collision cell in the mass spectrometer according to the present embodiment.

### DESCRIPTION OF EMBODIMENTS

Hereinafter, an embodiment of an ion spectrometer according to the present invention will be described with reference to the accompanying drawings.

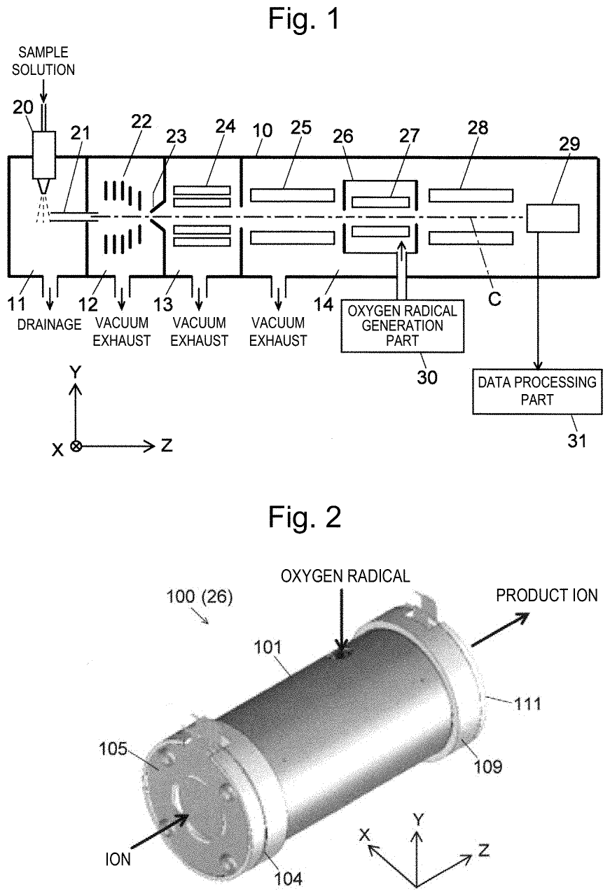

FIG. 1 is a schematic configuration diagram of a mass spectrometer according to the present embodiment. This mass spectrometer is a triple quadrupole mass spectrometer including an atmospheric pressure ion source. The mass spectrometer has a front stage often connected to a liquid chromatograph (LC), and is used as a liquid chromatograph mass spectrometer. For convenience of description, an X axis, a Y axis, and a Z axis orthogonal to each other are illustrated in FIG. 1.

As illustrated in FIG. 1, the mass spectrometer includes an ionization chamber 11 and a vacuum chamber 10. The inside of the ionization chamber 11 is a substantially atmospheric pressure atmosphere. The inside of the vacuum chamber 10 is divided into a plurality of sections, and the respective divided chambers are vacuum-exhausted by a vacuum pump (a rotary pump and/or a turbo-molecular pump) which is not illustrated, and are a first intermediate vacuum chamber 12, a second intermediate vacuum chamber 13, and an analysis chamber 14. That is, the mass spectrometer has a configuration of a multi-stage differential exhaust system in which the degree of vacuum sequentially increases from the ionization chamber 11 in a substantially atmospheric pressure atmosphere to the analysis chamber 14 in a high vacuum.

An electrospray ionization (ESI) probe 20 is installed in the ionization chamber 11, and an eluate (sample solution) eluted from a column of LC is introduced into the ESI probe 20, for example. The ionization chamber 11 and the first intermediate vacuum chamber 12 communicate with each other through a desolvation tube 21 having a small diameter. A kind of ion guide 22 called a Q array is disposed inside the first intermediate vacuum chamber 12. The first intermediate vacuum chamber 12 and the second intermediate vacuum chamber 13 communicate with each other via a small hole formed at a top of a skimmer 23. An ion guide 24 of a multipole type is disposed in the second intermediate vacuum chamber 13.

A front quadrupole mass filter 25, a collision cell 26, a rear quadrupole mass filter 28, and an ion detector 29 are disposed along an ion optical axis C that is linear in the analysis chamber 14 maintained at a high degree of vacuum. Here, the ion optical axis C is parallel to the Z axis. Each of the front quadrupole mass filter 25 and the rear quadrupole mass filter 28 has four rod electrodes disposed in parallel to the ion optical axis C to surround the ion optical axis C, and has a function of selecting ions according to a mass-to-charge ratio (strictly, italic “m/z”). An oxygen radical generation part 30 is connected to the collision cell 26, and the collision cell 26 has a function of dissociating ions by oxygen radicals supplied from the oxygen radical generation part 30. A multipole ion guide 27 is disposed inside the collision cell 26 to surround the ion optical axis C. Detection signals by the ion detector 29 is input to a data processing part 31 which is actually a computer.

A typical MS/MS analysis operation in the mass spectrometer of the present embodiment will be schematically described.

The ESI probe 20 nebulizes a supplied sample liquid into the ionization chamber 11 while applying a charge to the sample solution. A sample component in the nebulized charged droplets is ionized in a process in which the droplets are micronized and the solvent is vaporized. The generated ions derived from the sample component are sucked into the desolvation tube 21 with a gas flow produced by a pressure difference between both ends of the desolvation tube 21, and are sent to the first intermediate vacuum chamber 12. The ions travel substantially in the Z-axis direction, pass through the ion guide 22, an orifice of the skimmer 23, and the ion guide 24, are sent to the analysis chamber 14, and are introduced into the front quadrupole mass filter 25.

A voltage obtained by combining a DC voltage and a radio-frequency voltage is applied from a power source which is not illustrated to each rod electrode constituting the front quadrupole mass filter 25, and only ions having a specific mass-to-charge ratio corresponding to this voltage selectively pass through the front quadrupole mass filter 25, and are introduced into the collision cell 26. Oxygen radicals are supplied into the collision cell 26 from the oxygen radical generation part 30, and ions (generally referred to as precursor ions) introduced into the inside of the collision cell 26 react with the oxygen radicals and dissociate. Various types of product ions generated by the dissociation are converged by the action of an electric field formed by the ion guide 27, exit from the collision cell 26, and are introduced into the rear quadrupole mass filter 28.

A voltage obtained by combining a DC voltage and a radio-frequency voltage is applied to each rod electrode constituting the rear quadrupole mass filter 28 similarly to the front quadrupole mass filter 25, and only product ions having a specific mass-to-charge ratio corresponding to this voltage selectively pass through the rear quadrupole mass filter 28, and reach the ion detector 29. The ion detector 29 outputs detection signals according to the amount of incident ions to the data processing part 31.

For example, when it is desired to perform quantitative analysis of a sample component in which both mass-to-charge ratios of precursor ions and product ions are known, the mass-to-charge ratios of ions respectively selected by the front quadrupole mass filter 25 and the rear quadrupole mass filter 28 are fixed, and specific product ions generated from specific precursor ions are repeatedly detected. That is, multiple reaction monitoring (MRM) measurement for combination of the specific mass-to-charge ratios is repeated. The data processing part 31 creates a chromatogram (extracted ion chromatogram) based on the detection signals obtained by repeating the MRM measurement, and calculates the concentration (content) of the target sample component from the area of a peak observed in the chromatogram.

As the oxygen radical generation part 30, various types of oxygen radical generators as disclosed in, for example, Patent Literature 1, Non Patent Literature 1, and the like can be used. In addition, the mechanism of dissociation of ions using the reaction between oxygen radicals and ions (that is, the mechanism of HAD) is not a purpose of the present specification, and is described in various documents in addition to the above documents, and thus is omitted here.

As described above, in this mass spectrometer, the collision cell 26 has a function of dissociating the ions derived from the sample components by the action of oxygen radicals and transporting the product ions generated by the dissociating to the rear quadrupole mass filter 28.

Next, a structure of the collision cell 26 in the mass spectrometer of the present embodiment will be described in detail with reference to FIGS. 2 to 6.

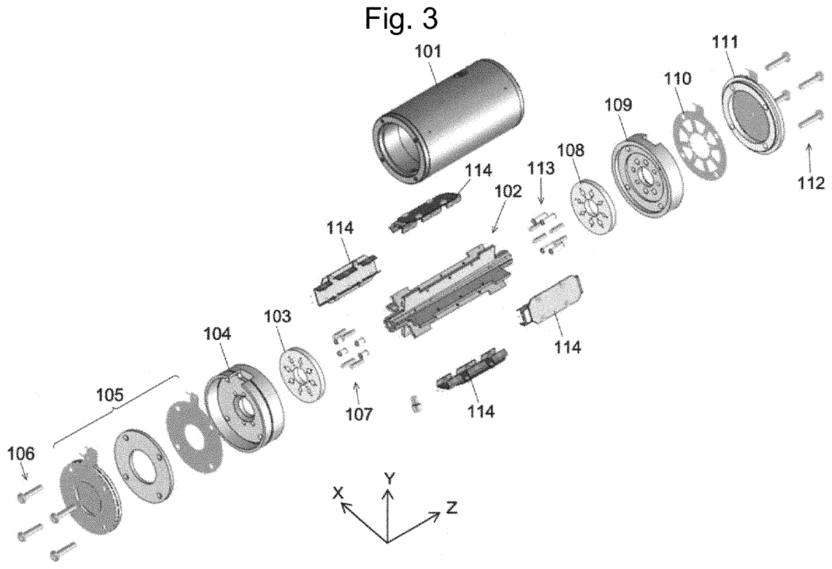

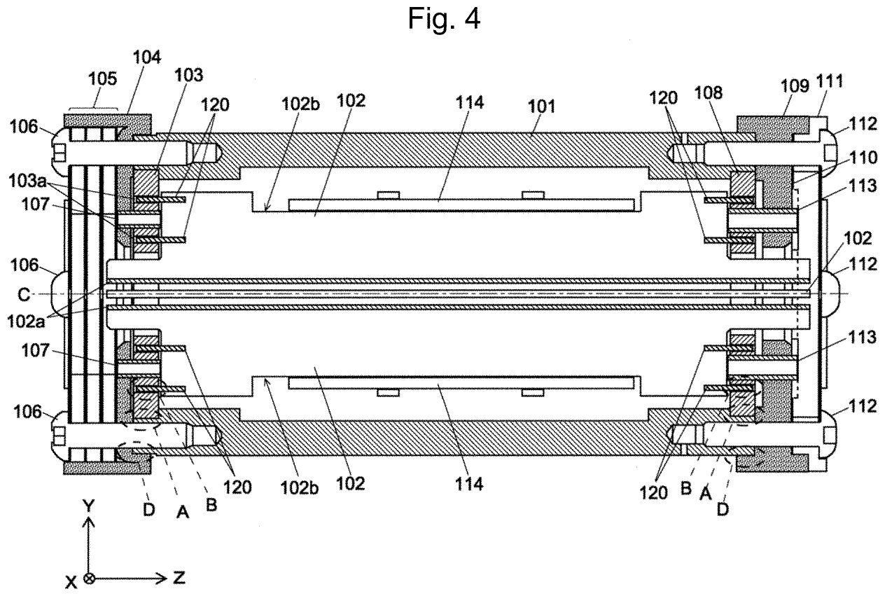

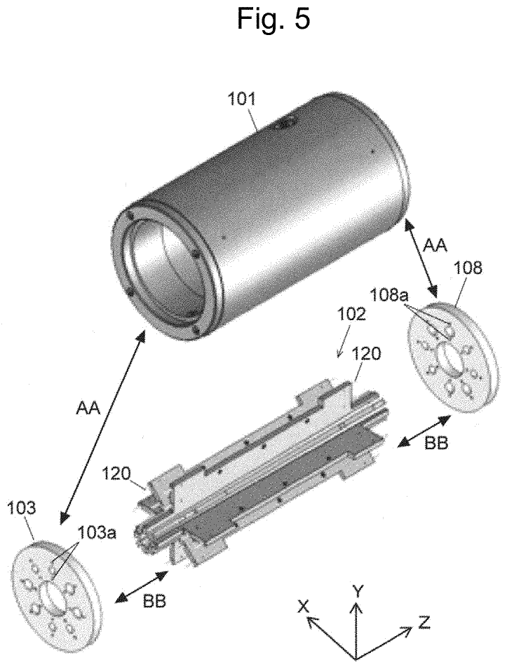

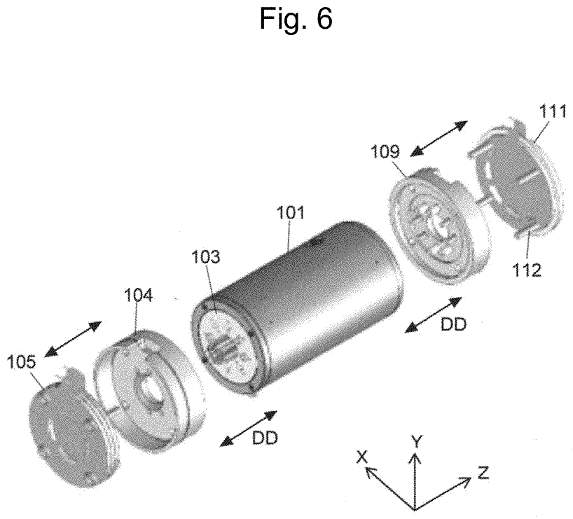

FIG. 2 is an external perspective view of a collision cell unit 100. FIG. 3 is an exploded perspective view of the collision cell unit 100. FIG. 4 is a schematic longitudinal sectional view of the collision cell unit 100. FIGS. 5 and 6 are mounting structural diagrams of components of the collision cell unit 100. Note that the collision cell unit 100 refer to a unit including the collision cell 26 and the ion guide 27 in FIG. 1.

As described above, the plurality of electrodes constituting the ion guide 27 are arranged inside the collision cell 26. The plurality of electrodes are illustrated by eight electrode plates 102 in FIGS. 3 and 5. In a collision cell configured to perform CID, the electrode plate is generally made of stainless steel. However, radical species, especially oxygen radicals, are highly reactive and therefore corrode stainless steel. Therefore, here, a gold film layer 102a is formed on a surface of each electrode plate 102 by providing gold plating on a surface of a base member made of stainless steel. However, the oxygen radical also forms an oxide on a surface of the gold film layer 102a. Therefore, in the mass spectrometer according to the present embodiment, in order to remove the oxide, a mechanism for heating the electrode plate 102 to about 150° C. is added without changing the configuration itself of the ion optical system, and a heat-resistant structure capable of heating the electrode plate 102 to about 150° C. is adopted.

As illustrated in FIG. 2, the collision cell unit 100 is a substantially columnar unit as a whole, and as indicated by arrows in FIG. 2, precursor ions are introduced into the inside of the collision cell 26 from the front side and product ions are emitted from the other side.

As illustrated in FIG. 3, main members constituting the collision cell unit 100 include a cylindrical case 101 having a substantially cylindrical shape, eight electrode plates 102, four heater units 114, a front inner holder 103 having a substantially disk shape, a front outer holder 104, an inlet electrode unit 105 including a plurality of electrode plates and an insulating spacer attached in front of the front outer holder 104, a rear inner holder 108 having a substantially disk shape, a rear outer holder 109, a plate spring 110 attached behind the rear outer holder 109, and an outlet electrode unit 111.

The cylindrical case 101 is made of aluminum. The front inner holder 103 and the rear inner holder 108 include ceramic, and have a melting point of 2000° C. or higher. The front outer holder 104 and the rear outer holder 109 include polyether ether ketone (PEEK) resin having high heat resistance among resins, and have a melting point of about 360° C.

The eight electrode plates 102 are radially disposed with the same angular interval in a circumferential direction around the ion optical axis C (Z axis). As illustrated in FIG. 4, a shape of one electrode plate 102 is a substantially rectangular shape in a plane extending in a substantially Z-axis direction, and both ends of the electrode plate 102 further extend in the substantially Z-axis direction. In addition, each of the electrode plates 102 has a notch 102b of a recessed shape on a corresponding outer peripheral side. As described above, each of the electrode plates 102 has the gold film layer 102a formed by gold plating on the surface of the base member made of stainless steel.

One heater unit 114 has a configuration in which a polyimide planar heater is sandwiched between two metal plates. The polyimide planar heater is a very thin heater having a structure in which a metal foil as a heating element is sandwiched between polyimide (PI) films as insulators. The above-described two metal plates are made of a metal having high thermal conductivity, for example, copper, and the two metal plates are fixed to each other with a screw and a nut in a state where the polyimide planar heater is sandwiched between them.

The one heater unit 114 is attached so as to bridge the notches 102b of the two electrode plates 102 adjacent in the circumferential direction. When the polyimide planar heater of the heater unit 114 is energized from the outside and the heating element generates heat, the heat is conducted to the two electrode plates 102 in contact with the heater unit 114 to heat the electrode plates 102. The heater unit 114 is thin and sufficiently fits in a depth of the notch 102b of the electrode plate 102. Therefore, as illustrated in FIG. 4, the heater unit 114 fits in a gap between the electrode plates 102 and an inner peripheral surface of the cylindrical case 101, and no change is required in the shape of the cylindrical case 101 also used in the collision cell mounted in a conventional tandem mass spectrometer or a shape of a portion related to electric field formation in the electrode plates 102.

The front inner holder 103 and the rear inner holder 108 of a substantially disk shape are fitted to inner peripheries of a front opening and a rear opening of the cylindrical case 101 so as to close the openings. The front outer holder 104 is a member having an outer diameter slightly larger than the outer diameter of the cylindrical case 101, and is placed outside the front inner holder 103, being fitted and attached to an outer peripheral side of the front opening of the cylindrical case 101. The rear outer holder 109 is a member having an outer diameter slightly larger than the outer diameter of the cylindrical case 101 similarly, and is placed outside the rear inner holder 108, being fitted and attached to an outer peripheral side of the front opening of the cylindrical case 101.

The front outer holder 104 has a flat cylindrical flange on its outer peripheral side, and the inlet electrode unit 105 is attached to the inside of the flange. Specifically, the electrode and the spacer included in the inlet electrode unit 105, the front outer holder 104, and the front inner holder 103 are pierced with screw holes in straight lines along the Z-axis direction. Then, as illustrated in FIG. 4, four screws 106 each made of an insulator (PEEK resin in this example) are inserted into the screw holes and screwed into screw holes of the cylindrical case 101, whereby the inlet electrode unit 105, the front outer holder 104, and the front inner holder 103 are fixed to the cylindrical case 101.

On the other hand, the outlet electrode unit 111 has substantially the same outer diameter as the rear outer holder 109, and the outlet electrode unit 111, the plate spring 110, the rear outer holder 109, and the rear inner holder 108 are pierced with screw holes in straight lines along the Z-axis direction. Then, as illustrated in FIG. 4, four screws 112 each made of an insulator (PEEK resin in this example) are inserted into the screw holes and screwed into the screw holes of the cylindrical case 101, whereby the outlet electrode unit 111, the plate spring 110, the rear outer holder 109, and the rear inner holder 108 are fixed to the cylindrical case 101.

Two electrode support pins 120 having a small diameter and a rod shape are press-fitted into surfaces of each of the electrode plates 102 respectively facing the front inner holder 103 and the rear inner holder 108 (surfaces having a thickness of the electrode plates 102 as a width) so as to extend parallel to the ion optical axis C (Z axis). That is, the two electrode support pins 120 are provided in a projecting manner on each of the front side and the rear side of the one electrode plate 102. The electrode support pins 120 are made of stainless steel. On predetermined positions of the front inner holder 103 and the rear inner holder 108, pin holes 103a and 108a are respectively formed, the inner diameters of them allowing the electrode support pins 120 protruding from each of the corresponding electrode plates 102 to be inserted into the pin holes 103a and 108a. That is, the 16 pin holes 103a and the 16 pin holes 108a are formed in the front inner holder 103 and the rear inner holder 108, respectively. Positions of the electrode plates 102 are determined in the circumferential direction by the electrode support pins 120 protruding in the opposite directions from each other being inserted into the pin holes 103a of the front inner holder 103 and the pin holes 108a of the rear inner holder 108.

Spacers 107 of a cylindrical shape are inserted into holes formed in the front outer holder 104 and the front inner holder 103. Then, a front edge end of each spacer 107 is substantially flush with a front surface of the front outer holder 104 and abuts on the inlet electrode unit 105, and a rear edge end protrudes slightly rearward from a rear surface of the front inner holder 103. Likewise, spacers 113 of a cylindrical shape are inserted into holes formed in the rear outer holder 109 and the rear inner holder 108. Then, a rear edge end of each spacer 113 protrudes slightly rearward from a rear surface of the rear outer holder 109 and abuts on the plate spring 110, and a front edge end protrudes slightly forward from a front surface of the rear inner holder 108.

There are two types of spacers 107 and 113, that is, a spacer made of ceramic and the other made of stainless steel. The spacers made of ceramic function purely as a spacer, whereas the spacers made of stainless steel function as wiring for applying a voltage to the electrode plates 102 from the outside. Such spacers made of stainless steel are in contact with the electrode plates 102 and the like with a weak force of about 1 to 2 N capable of obtaining electrical contact, and thus thermal resistance of the spacers is sufficiently large, and thermal conduction through the spacers is almost negligible.

The plate spring 110 sandwiched between the rear outer holder 109 and the outlet electrode unit 111 receives a pressing force from the front by the spacers 113, and biases the spacers 113 forward against the pressing force. Since a front end of each spacer 113 abuts on the electrode plate 102, the spacer 113 pushes the electrode plates 102 forward. On the other hand, a front end of each spacer 107 abutting on the front edge side of the electrode plates 102 is positionally regulated by the inlet electrode unit 105. Therefore, the electrode plates 102 are positioned in the Z-axis direction by the biasing force of the plate spring 110. At this time, slight gaps are formed between the electrode plates 102 and the front inner holder 103 and between the electrode plates 102 and the rear inner holder 108, respectively, and the electrode plates 102 and the front inner holder 103 are not in contact with each other, and the electrode plates 102 and the rear inner holder 108 are not in contact with each other.

Therefore, the electrode plates 102 are held in a state of being positioned in the circumferential direction by the front inner holder 103 and the rear inner holder 108 via the electrode support pins 120. In addition, in this state, the electrode plates 102 are not in direct contact with either the front inner holder 103 or the rear inner holder 108, and are in contact with the front inner holder 103 and the rear inner holder 108 only via the electrode support pins 120 and the spacers 113.

As described above, a plurality of components made of different materials are used for the collision cell unit 100. The materials used have different heat resistant temperatures and different thermal expansion coefficients. For example, ceramic having high heat resistance used for the front inner holder 103 and the rear inner holder 108 has a thermal expansion coefficient of about 7 [PPM/° C.]. Stainless steel as a base member of the electrode plate 102 has a thermal expansion coefficient of about 16 [PPM/° C.], and aluminum used for the cylindrical case 101 has a thermal expansion coefficient of about 23 [PPM/° C.]. PEEK used for the front outer holder 104 and the rear outer holder 109 has high heat resistance as resin and has a thermal expansion coefficient of about 50 [PPM/° C.].

The electrode plates 102 are heated to about 150° C. at maximum by the heater units 114, but each electrode support pin 120 is made of stainless steel having relatively low thermal conductivity and has a small cross-sectional area, thereby having large thermal resistance. Therefore, the heat of the electrode plates 102 is hardly transmitted to the front inner holder 103 and the rear inner holder 108. The front inner holder 103 and the rear inner holder 108 holding the electrode support pins 120 are made of ceramic and have not only high heat resistance but also a low thermal expansion coefficient. In addition, as described above, thermal conduction via the spacers is also negligible. Therefore, even if temperatures of the front inner holder 103 and the rear inner holder 108 rise, the interval (relative position) between the pin holes 103a (108a) hardly changes, and the positions of the eight electrode plates 102 surrounding the ion optical axis C hardly change. On the other hand, unlike resins, ceramics are difficult to mold, and a shape of components that can be manufactured is largely restricted. On the other hand, in the apparatus according to the present embodiment, the electrode holder is divided into the outer components and the inner components, and PEEK is used for the front outer holder 104 and the rear outer holder 109. Therefore, the electrode holders can have a shape suitable for mounting the inlet electrode unit 105 and the outlet electrode unit 111 while having heat resistance.

In addition, in a case where components made of different materials are combined as described above, thermal stress due to a difference in thermal expansion coefficient between the different components occurs at a place where the components are in contact with each other, and each component may be plastically deformed. In order to avoid this, a gap that absorbs thermal expansion is provided at a place where the components of different materials are in contact with each other, and a size of the gap is determined to be substantially the same as that of the current apparatus (apparatus described in Non Patent Literature 1) in a state where maximum thermal expansion is assumed.

Furthermore, in a case where components having different thermal expansion coefficients come into contact with each other (come into contact with each other while having the above-described gap), the component having the larger thermal expansion coefficient is disposed outside or outward, that is, in a side where a larger escape space is secured, so that the occurrence of thermal stress is reduced. That is, the front outer holder 104 and the rear outer holder 109 made of PEEK having a larger thermal expansion coefficient and the cylindrical case 101 made of aluminum are disposed outward of the front inner holder 103 and the rear inner holder 108 made of ceramic having the lowest thermal expansion coefficient.

Specifically, in the mass spectrometer according to the present embodiment, a gap at each place where the components of different materials are in contact with each other is as follows.

(1) A set value of a gap (A in FIG. 4 and AA in FIG. 5) between an outer peripheral surfaces of the front inner holder 103 and the rear inner holder 108 made of ceramic and an inner peripheral surface of the cylindrical case 101 is 0.10 to 0.17 mm (0 to 0.2 mm in the current apparatus). As a result, an assumed value of the gap when the maximum thermal expansion occurs is 0.06 mm, and thermal stress can be avoided.

(2) A set value of a gap (B in FIG. 4 and BB in FIG. 5) between an outer peripheral surface of each of the electrode support pins 120 protruding from the electrode plates 102 and each of inner peripheral surfaces of the pin holes 103a and 108a formed in the front inner holder 103 and the rear inner holder 108 is 0.012 to 0.068 mm (0.005 to 0.08 mm in the current apparatus). As a result, an assumed value of the gap when the maximum thermal expansion occurs is 0.01 mm.

(3) A set value of a gap (C in FIG. 4 and DD in FIG. 6) between an outer peripheral surface of the cylindrical case 101 and inner peripheral surfaces of the front outer holder 104 and the rear outer holder 109 is 0.007 to 0.07 mm (0.005 to 0.089 mm in the current apparatus). In this case, the gap becomes larger than the set value when thermal expansion occurs.

With the above-described configuration, even when the electrode plate 102 is heated to about 150° C., it is possible to avoid occurrence of plastic deformation due to thermal stress occurring in each component. In addition, since relative positions of the eight electrode plates 102 and the positions of the electrode plates 102 with respect to the ion optical axis C hardly change, there is no significant change in a shape of an electric field formed by the voltage applied to the electrode plates 102. Thereby, the influence of heat on the behavior of ions can be suppressed. In addition, the inlet electrode unit 105 and the outlet electrode unit 111 are exactly the same as those of the current apparatus, and a substantial shapes of the electrode plates 102 are also the same as those of the current apparatus. Therefore, the ion optical system itself is no different from the current apparatus, and a decrease in ion convergence efficiency or the like due to a configuration capable of heating the electrode plates 102 does not occur. A size of the collision cell unit 100 is also equivalent to that of the current apparatus.

The materials of the components constituting the collision cell unit 100 described above are merely examples, and are not necessarily limited to those illustrated. Similarly, the shape of each component is not necessarily limited to the example.

The heater unit may not directly heat the electrode plates, and may heat the electrode plates by radiant heat of a heater attached to the cylindrical case, for example.

In addition, although the mass spectrometer of the above embodiment is a triple quadrupole mass spectrometer, it is reasonable that the collision cell unit 100 having the above-described configuration can also be used for a quadrupole-time-of-flight mass spectrometer.

Furthermore, it is reasonable that the collision cell unit 100 having the above-described configuration can also be used for an ion mobility spectrometer that separates and detects ions generated by dissociation in a collision cell according to ion mobility, or an ion mobility-mass spectrometer that selects specific ions according to ion mobility, dissociates the selected ions in a collision cell, and performs mass spectrometry of the ions generated by the dissociation. That is, the present invention can be applied to all spectrometers including a collision cell configured to dissociate ions using radical species.

### [Various Modes]

It will be understood by those skilled in the art that the exemplary embodiments described above are specific examples of the following modes.

(Clause 1) A mode of an ion spectrometer according to the present invention is an ion spectrometer including a reaction chamber configured to dissociate ions derived from a sample component by causing the ions to react with radical species, the ion spectrometer including:
a cylindrical part constituting a part of the reaction chamber and having openings at both ends;
a plurality of electrodes disposed inside the cylindrical part to surround an axis that is linear along an extending direction of the cylindrical part, the electrodes extending in a direction along the axis;
a heating part configured to heat the plurality of electrodes;
a pair of electrode holding parts respectively provided in openings at both ends of the cylindrical part and having holes into which electrode support pins described later are respectively inserted; and
the electrode support pins of a rod shape each provided on a surface facing the pair of electrode holding parts in each of the plurality of electrodes and extending parallel to the axis.

In the ion spectrometer according to Clause 1, the electrode support pins connecting the electrode holding part and the electrodes have functions of both heat insulation and positioning the electrodes. Therefore, with the ion spectrometer according to Clause 1, since the electrodes for ion convergence and transportation disposed in the reaction chamber can be appropriately heated in vacuum, an oxide formed on the surfaces of the electrodes due to an action of radical species can be removed. Accordingly, oxidation and corrosion of the electrodes can be prevented, and high reliability can be secured for a long period of time.

(Clause 2) In the ion spectrometer according to Clause 1, the plurality of electrodes may have a gold or platinum layer on a surface of a metal as a base member.

With the ion spectrometer according to Clause 2, an oxide formed on a surface of an electrode plate can be removed only by heating the electrode plate to a relatively low temperature of, for example, about 150° C.

(Clause 3) In the ion spectrometer according to Clause 2, the metal of the base member may be stainless steel.

Stainless steel is a relatively inexpensive metal. Therefore, with the ion spectrometer according to Clause 3, cost of the electrode plates can be suppressed.

(Clause 4) In the ion spectrometer according to any one of Clause 1 to Clause 3, the electrode support pins may be made of stainless steel.

Stainless steel is not only inexpensive but also a metal having low thermal conductivity. In addition, a commercially available pin made of stainless steel whose outer surface is finished to the roughness of about +10 μm or less has very high dimensional accuracy, and is also very inexpensive because it is a mass-produced product. In the ion spectrometer according to Clause 4, such a stainless steel pin can be used as the electrode support pins, and high heat insulating properties can be imparted while the cost of the electrode support pins is suppressed.

(Clause 5) In the ion spectrometer according to any one of Clause 1 to Clause 4, the pair of electrode holding parts may be made of a material having heat resistance and low thermal expansion coefficient.

(Clause 6) In the ion spectrometer according to Clause 5, the pair of electrode holding parts may be made of ceramic.

With the ion spectrometer according to Clauses 5 and 6, even when the temperatures of the electrode holding parts are increased to some extent due to the propagation of heat through the electrode support pins or the like, a change in dimensions such as an interval between pin holes can be suppressed, and positional displacement of the electrode plates can be prevented. Accordingly, it is possible to avoid disturbance of an electric field formed by a voltage applied to the electrode plates at the time of analysis and to maintain high performance such as high ion convergence.

(Clause 7) In the ion spectrometer according to any one of Clauses 1 to 6, the pair of electrode holding parts may be respectively fitted inside the openings at both ends of the cylindrical part, and
a pair of lid parts made of resin having lower heat resistance compared to the electrode holding parts and fitted to both end edge portions of the cylindrical part may be further included outside the pair of electrode holding parts.

(Clause 8) In the ion spectrometer according to Clause 7, the pair of lid parts may be made of polyether ether ketone.

While having high heat resistance, ceramics have poor processability and are greatly restricted in a shape of components. On the other hand, a highly heat-resistant resin such as polyether ether ketone is inferior in heat resistance to ceramics, but has good processability and little restriction on the shape of components. Therefore, with the ion spectrometer according to Clauses 7 and 8, it is possible to easily manufacture a lid part having a shape suitable for assembling, for example, an inlet electrode unit, an outlet electrode unit, or the like.

(Clause 9) In the ion spectrometer according to Clause 7 or 8, a material constituting the cylindrical part and the pair of lid parts may have a larger thermal expansion coefficient compared to a material constituting the pair of electrode holding parts.

With the ion spectrometer according to Clause 9, even when a temperature of each component such as the cylindrical part, the lid part, and the electrode holding parts rises, since the components positioned relatively outside have a larger thermal expansion coefficient, it is possible to easily secure a gap between the components and to prevent the occurrence of thermal stress.

### REFERENCE SIGNS LIST

10 . . . Vacuum Chamber
11 . . . Ionization Chamber
12 . . . First Intermediate Vacuum Chamber
13 . . . Second Intermediate Vacuum Chamber
14 . . . Analysis Chamber
20 . . . Electrospray Ionization (ESI) Probe
21 . . . Desolvation Tube
22, 24, 27 . . . Ion Guide
23 Skimmer
25 . . . Front Quadrupole Mass Filter
26 . . . Collision Cell
28 . . . Rear Quadrupole Mass Filter
29 . . . Ion Detector
30 . . . Oxygen Radical Generation Part
31 . . . Data Processing Part
C . . . Ion Optical Axis
100 . . . Collision Cell Unit
101 . . . Cylindrical Case
102 . . . Electrode Plate
102a . . . Gold Film Layer
102b . . . Notch
103 . . . Front Inner Holder
103a . . . Pin Hole
104 . . . Front Outer Holder
105 . . . Inlet Electrode Unit
106, 112 . . . Screw
107, 113 . . . Spacer
108 . . . Rear Inner Holder
109 . . . Rear Outer Holder
111 . . . Outlet Electrode Unit
114 . . . Heater Unit
120 . . . Electrode Support Pin

1. An ion spectrometer including a reaction chamber configured to dissociate ions derived from a sample component by causing the ions to react with radical species, the ion spectrometer comprising:
a cylindrical part constituting a part of the reaction chamber and having openings at both ends;
a plurality of electrodes disposed inside the cylindrical part to surround an axis that is linear along an extending direction of the cylindrical part, the electrodes extending in a direction along the axis;
a heating part configured to heat the plurality of electrodes;
a pair of electrode holding parts respectively provided in openings at both ends of the cylindrical part and having holes into which electrode support pins described later are respectively inserted; and
the electrode support pins of a rod shape each provided on a surface facing the pair of electrode holding parts in each of the plurality of electrodes and extending parallel to the axis.

2. The ion spectrometer according to claim 1, wherein the plurality of electrodes have a gold or platinum layer on a surface of a metal as a base member.

3. The ion spectrometer according to claim 2, wherein the metal of the base member is stainless steel.

4. The ion spectrometer according to claim 1, wherein the electrode support pins are made of stainless steel.

5. The ion spectrometer according to claim 1, wherein the pair of electrode holding parts are made of a material having heat resistance and low thermal expansion coefficient.

6. The ion spectrometer according to claim 5, wherein the pair of electrode holding parts are made of ceramic.

7. The ion spectrometer according to claim 1, wherein the pair of electrode holding parts are respectively fitted inside the openings at both ends of the cylindrical part, and
a pair of lid parts made of resin having lower heat resistance compared to the electrode holding parts and fitted to both end edge portions of the cylindrical part are further included outside the pair of electrode holding parts.

8. The ion spectrometer according to claim 7, wherein the pair of lid parts are made of polyether ether ketone.

9. The ion spectrometer according to claim 7, wherein a material constituting the cylindrical part and the pair of lid parts has a larger thermal expansion coefficient compared to a material constituting the pair of electrode holding parts.
